(19) United States
(12) Patent Application Publication
(10) Pub. No.: US 2013/0311564 A1
(43) Pub. Date: Nov. 21, 2013

(54) SENDER DEVICE AND METHOD OF SHARING SCREENSHOTS AND COMPUTER-READABLE MEDIUM THEREOF

(71) Applicant: AWIND, INC, New Taipei City (TW)

(72) Inventors: Kuo-Lung CHANG, New Taipei City (TW); Cheng-Hsiung CHANG, New Taipei City (TW); Meng-Chung HUNG, New Taipei City (TW); Shih-Ping LIU, New Taipei City (TW); Kuan-Yu CHOU, New Taipei City (TW); Hsing-Yung WANG, New Taipei City (TW)

(73) Assignee: Awind, Inc, New Taipei City (TW)

(21) Appl. No.: 13/893,244

(22) Filed: May 13, 2013

(30) Foreign Application Priority Data
May 15, 2012 (TW) 101117197

(51) Int. Cl. H04W 8/24

(52) U.S. Cl. CPC H04W 8/24
USPC 709/204

(57) ABSTRACT

A sender device of sharing screenshots comprises a detection module, a control module and a wireless network interface. The detection module detects in the background whether a user is executing a screenshot activity and outputs a corresponding trigger signal. The control module electrically connects with the detection module and retrieves a latest-taken screenshot according to the trigger signal output by the detection module. The wireless network interface electrically connects the control module for establishing a wireless network link with a receiver device and transmitting the screenshot to the receiver device. The abovementioned sender device is able to simplify the operation to share screenshots.

### BACKGROUND OF THE INVENTION

1. Field of the Invention

The present invention relates to a sender device and method of sharing screenshots, and more particularly to a sender device and method of sharing screenshots, which can simplify the operation of sharing screenshots.

2. Description of the Prior Art

The popularization of handheld devices, such as smart phones and tablet computers, has driven the diversification of the contents thereof. Thus, there are more and more chances to share screen frames of handheld devices. For an example, the user can use a screenshot function of a handheld device to shoot the mission-completed screen frame of a game and then uses communication software to transmit the shot screen frame to friends or others. For another example, a teacher may shoot specified screen frames of operating an application program and use them in instruction. However, the user cannot share screenshots with others or transmit screenshots to a computer, a television or a projector unless the user makes some extra operations, which are likely to inconvenience the user.

For example, in application program instruction, the teacher may need specified screen frames of operating the application program to make students understand easily. A conventional way to do it is storing the screenshots of the operation steps one by one or fabricating the screenshots into projection slides. Then, the teacher can use the screenshots to demonstrate the application program. However, such a way cannot instantly show specified screen frames of the operation of the application program to deal with unexpected situations, such as the questions asked by students during class. Another conventional way is: once a screenshot has been taken, the instructed application program is switched to another program for transmitting the taken screenshot to a display device; then, the instructed application program is restored again for taking the next screenshot. The repeated switches of the application program interrupt the continuity of instruction and affect the rhythm of instruction.

Therefore, how to simplify the operation of sharing screenshots has become a problem the manufacturers are eager to solve.

### SUMMARY OF THE INVENTION

The present invention is directed to a sender device and method of sharing screenshots and a computer-readable medium thereof, wherein the sender side detects whether the user is taking screenshots, and wherein the sender side automatically retrieves the screenshot taken by the user latest and transmits it to the receiver side, whereby is simplified the operation of sharing screenshots.

A first embodiment of the present invention proposes a sender device of sharing screenshots, which cooperates with a receiver device to form a screenshot sharing system. The sender device comprises a detection module, a control module and a wireless network interface. The detection module detects in the background whether the user is taking screenshots and outputs a corresponding trigger signal. The control module electrically connects with the detection module and retrieves a screenshot taken by the user latest according to the trigger signal output by the detection module. The wireless network interface electrically connects with the control module to establish a wireless network link with the receiver device and transmit the screenshot to the receiver device.

A second embodiment of the present invention proposes a method of sharing screenshots, which comprises steps: establishing a wireless network link between a sender device and a receiver device; the sender device detecting in the background whether the user is taking screenshots; if the user is taking screenshots, the sender device retrieving a screenshot taken by the user latest; if the user does not take any screenshot, the sender device keeping on detection; the sender device transmitting the taken screenshot to the receiver device; and the receiver device using an external or built-in display module to present the screenshot transmitted by the sender device.

A third embodiment of the present invention proposes a method of transmitting screenshots, which is applied to a sender device and comprises steps: establishing a wireless network link between a sender device and a receiver device; detecting in the background whether the user is taking screenshots; if yes, retrieving a screenshot taken latest; if no, keeping on detection; and transmitting the taken screenshot to the receiver device.

A fourth embodiment of the present invention proposes a computer-readable medium, which stores a computer program that can be loaded into a sender device to execute a method of transmitting screenshots. The method of transmitting screenshots comprises steps: establishing a wireless network link between a sender device and a receiver device; detecting in the background whether the user is taking screenshots; if yes, retrieving a screenshot taken latest; if no, keeping on detection; and transmitting the taken screenshot to the receiver device.

The objective, technologies, features and advantages of the present invention will become apparent from the following description in conjunction with the accompanying drawings wherein certain embodiments of the present invention are set forth by way of illustration and example.

### BRIEF DESCRIPTION OF THE DRAWINGS

The foregoing conceptions and their accompanying advantages of this invention will become more readily appreciated after being better understood by referring to the following detailed description, in conjunction with the accompanying drawings, wherein:

FIG. 1 is a diagram schematically illustrating a sender device of sharing screenshots according to one embodiment of the present invention;

FIG. 2 is a flowchart schematically illustrating a method of sharing screenshots according to one embodiment of the present invention; and

FIG. 3 is a flowchart schematically illustrating a method of transmitting screenshots according to one embodiment of the present invention.

### DESCRIPTION OF THE PREFERRED EMBODIMENT

The detailed explanation of the present invention is described as follows. The described preferred embodiments are presented for purposes of illustrations and description, and they are not intended to limit the scope of the present invention.

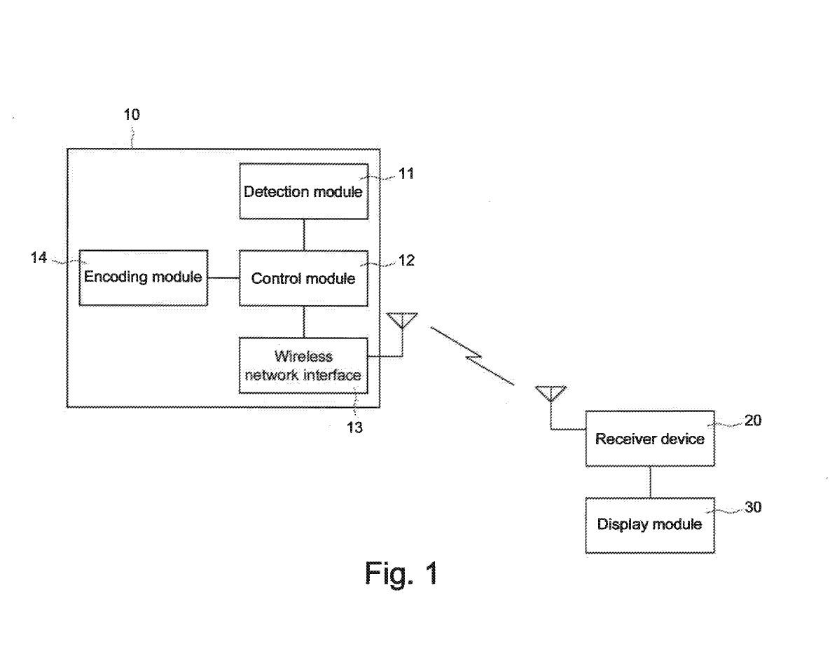

Refer to FIG. 1 schematically showing a sender device of sharing screenshots according to one embodiment of the present invention. The sender device 10 cooperates with a receiver device 20 to form a screenshot sharing system. For example, the sender device 10 may be but is not limited to be a handheld device, such as a smart phone or a tablet computer. The sender device 10 comprises a detection module 11, a control module 12 and a wireless network interface 13. The detection module 11 detects in the background whether the user is taking screenshots. If the user is taking screenshots, the detection module 11 outputs a corresponding trigger signal. The user can input an instruction whose contents depend on the operating system or software of the handheld device to execute a screenshot activity. For example, in the background, the detection module 11 detects the input signal of HID (Human Interface Device), such as a touch screen or a button, to determine whether the user is executing a screenshot activity.

The control module 12 electrically connects with the detection module 11 and retrieves a screenshot taken by the user latest according to the trigger signal output by the detection module 11. For example, the screenshot taken by the user is stored in a storage path preset by the operating system or software of the handheld device. The control module 12 retrieves the newest picture in the storage path as the latest-taken screenshot. The wireless network interface 13 electrically connects with the control module 12 for establishing a wireless network link with the receiver device 20. For example, the wireless network link works according to the IEEE 802.11-based communication standard. The control module 12 transmits the latest-taken screenshot to the receiver device 20 through the wireless network interface 13. The receiver device 20 uses an external or built-in display module 30 to present the screenshot transmitted by the sender device 10. For example, the receiver device 20 is a handheld device whose built-in display unit can present the screenshot transmitted the sender device 10. Alternatively, the receiver device 20 connects with a display device (such as a computer display, a television or a projector) through a video connection interface (such as a VGA (Video Graphic Array) port, DVI (Digital Visual Interface), or HDMI (High Definition Multimedia Interface)) to present the screenshot transmitted by the sender device 10.

The screenshot is normally taken by the operating system through software. Therefore, the taken screenshot is free of distortion. Because of limitation of bandwidth or in order to reduce the occupied bandwidth, the screenshot may be encoded to reduce the data volume before transmission. In one embodiment, the sender device of sharing screenshots further comprises an encoding module 14, which electrically connects with the control module 12 and encodes the screenshot retrieved by the control module 12 to reduce the data volume.

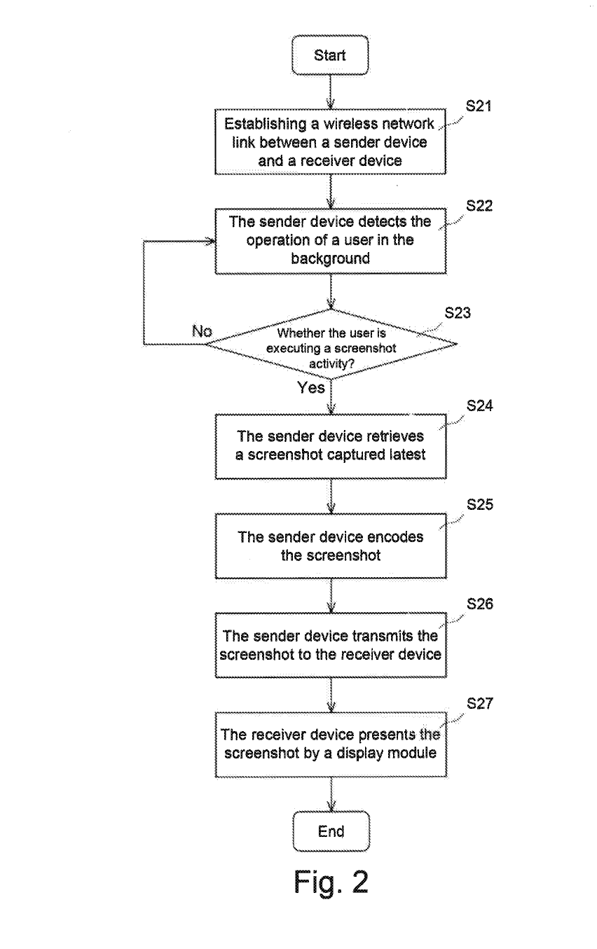

Below is described a method of sharing screenshots according to one embodiment of the present invention. Refer to FIG. 1 and FIG. 2. Firstly, a wireless network link is established between a sender device 10 and a receiver device 20 (Step S21). For example, the receiver device 20 enables a software- or hardware-based network connection module beforehand; the sender device 10 scans the receivers 20 within the communication range and selects appropriate receiver devices 20 to establish wireless network links therebetween. Alternatively, the sender device 10 enables a network connection module beforehand; and then the receiver devices 20 actively establish wireless network interfaces with the sender device 10. Next, the sender device 10 detects the operations of the user in the background (Step S22) and identifies whether the user is taking screenshots (Step S23). If the user does not take any screenshot, the sender device 10 returns to Step S22 and continues detection. If the user is taking screenshots, the sender device 10 retrieves the latest-taken screenshot (Step S24) and transmits the retrieved screenshot to the receiver device 20 (Step S26). Preferably, the sender device 10 encodes the retrieved screenshot before transmission to reduce the data volume (Step S25). Then, the receiver device 20 uses an external or built-in display module 30 to present the screenshot transmitted by the sender device 10 (Step S27).

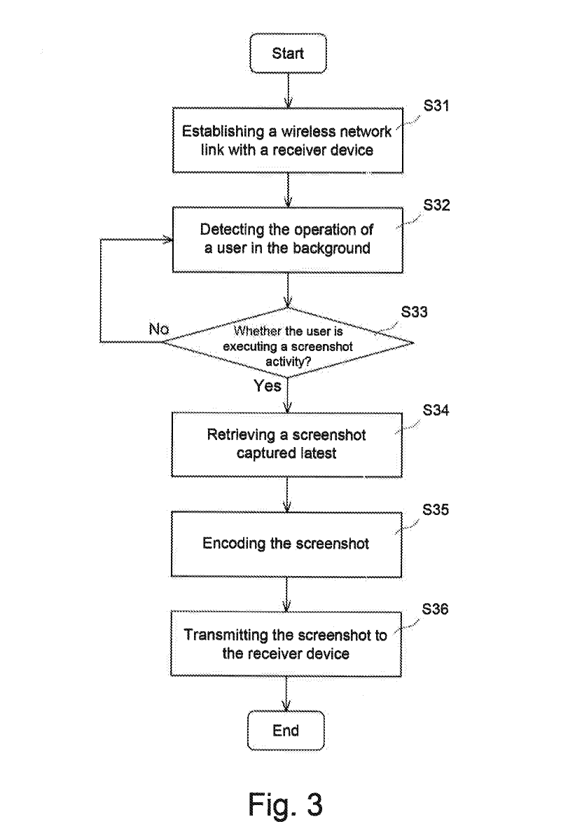

Below is described a method of transmitting screenshots according to one embodiment of the present invention. Refer to FIG. 1 and FIG. 3. The method of transmitting screenshots is applied to a sender device 10. Firstly, the sender device 10 establishes a wireless network link with a receiver device 20 (Step S31). Next, the sender device 10 detects the operations of the user in the background (Step S32) and identifies whether the user is taking screenshots (Step S33). If the user does not take any screenshot, the sender device 10 returns to Step S32 and continues detection. If the user is taking screenshots, the sender device 10 retrieves the latest-taken screenshot (Step S34) and transmits the retrieved screenshot to the receiver device 20 (Step S36). Preferably, the sender device 10 encodes the retrieved screenshot before transmission to reduce the data volume (Step S35).

The present invention also discloses a computer-readable medium. The computer-readable medium stores a computer program that can be loaded into a sender device to execute the method of transmitting screenshots shown in FIG. 3, which has been described hereinbefore and will not repeat herein.

In conclusion, the present invention proposes a sender device and method of sharing screenshots and a computer-readable medium thereof, wherein the sender side detects whether the user is taking screenshots, wherein the sender side automatically retrieves the screenshot taken by the user latest and transmits it to the receiver side, whereby is simplified the operation of sharing screenshots. In the present invention, the sender side directly shares screenshots through point-to-point wireless network links without knowing the private information of the receiver sides, such as the telephone numbers or the email account. In the present invention, the user can share the screen frames of the operation of an application program, neither preparing screenshots beforehand nor switching programs repeatedly.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A sender device of sharing screenshots, which cooperates with a receiver device to form a screenshot sharing system, and which comprises
a detection module configured for detecting in a background whether a user is executing a screenshot activity and outputting a corresponding trigger signal;
a control module electrically connecting with said detection module and configured for retrieving a screenshot taken latest according to said trigger signal; and
a wireless network interface electrically connecting with said control module for establishing a wireless network link with said receiver device and transmitting said screenshot to said receiver device.

2. The sender device of sharing screenshots according to claim 1 further comprising an encoding module electrically connecting with said control module and configured for encoding said screenshot.

3. The sender device of sharing screenshots according to claim 1, wherein said receiver device includes an external display module or a built-in display module for presenting said screenshot.

4. The sender device of sharing screenshots according to claim 1, wherein said wireless network link works according to an IEEE 802.11-based communication standard.

5. A method of sharing screenshots, comprising steps:
establishing a wireless network link between a sender device and a receiver device;
said sender device detecting in a background whether a user is executing a screenshot activity; if yes, said sender device retrieving a screenshot taken latest; if no, said sender device continuing detection;
said sender device transmitting said screenshot to said receiver device; and
said receiver device using an external display module or a built-in display module to present said screenshot.

6. The method of sharing screenshots according to claim 5 further comprising a step: said sender device encoding said screenshot.

7. The method of sharing screenshots according to claim 5, wherein said wireless network link works according to an IEEE 802.11-based communication standard.

8. A method of transmitting screenshots, which is applied to a sender device, and which comprises steps:
establishing a wireless network link with a receiver device;
detecting in a background whether a user is executing a screenshot activity; if yes, retrieving a screenshot taken latest; if no, continuing detection; and
transmitting said screenshot to said receiver device.

9. The method of transmitting screenshots according to claim 8 further comprising a step: encoding said screenshot.

10. The method of transmitting screenshots according to claim 8, wherein said wireless network link works according to an IEEE 802.11-based communication standard.

11. A computer-readable medium, which stores a computer program that is loaded into a sender device to execute a method of transmitting screenshots comprising steps:
establishing a wireless network link with a receiver device;
detecting in a background whether a user is executing a screenshot activity; if yes, retrieving a screenshot taken latest; if no, continuing detection; and
transmitting said screenshot to said receiver device.

12. The computer-readable medium according to claim 11, wherein said method further comprises a step: encoding said screenshot.

13. The computer-readable medium according to claim 11, wherein said wireless network link works according to an IEEE 802.11-based communication standard.
